(19) United States
(12) Patent Application Publication
(10) Pub. No.: US 2015/0068258 A1
(43) Pub. Date: Mar. 12, 2015

(54) KEY HOLDER ASSEMBLY

(71) Applicants: Hong Jiang, Westfield, NJ (US); Benjamin Jiang Cymbala, Westfield, NJ (US)

(72) Inventors: Hong Jiang, Westfield, NJ (US); Benjamin Jiang Cymbala, Westfield, NJ (US)

(21) Appl. No.: 14/180,769

(22) Filed: Feb. 14, 2014

Related U.S. Application Data
(60) Provisional application No. 61/876,728, filed on Sep. 11, 2013.
(60) Provisional application No. 61/877,970, filed on Sep. 14, 2013.
(60) Provisional application No. 61/919,822, filed on Dec. 23, 2013.

(51) Int. Cl. A44B 15/00; F16B 45/02

(52) U.S. Cl. CPC A44B 15/00; F16B 45/02
USPC 70/456 R; 24/601.5

(57) ABSTRACT

The current disclosure discloses certain embodiments of a key holder assembly. A key holder assembly may include one or more key holders of different shapes or sizes attached to one another. A secure locking mechanism for the carabineer was invented to prevent it from accidentally opening. Each key holder assembly forms a tree structure through the fastening mechanisms and the attachment mechanism of key holders. The tree structure can be dynamically configured to reflect the relationship of the keys. Keys are attached to the tree structure which facilitates the organization of the keys. The current invention helps owners or managers of one or more residential or commercial properties to better organize keys to their properties by mapping the relationship of the keys to a tree structure and storing the keys accordingly.

### CROSS REFERENCE TO RELATED APPLICATIONS

Pursuant to 35 U.S.C. §119(e), this application claims priority to U.S. Provisional Application Ser. No. 61/876,728, filed Sep. 11, 2013, U.S. Provisional Application Ser. No. 61/877,970, filed Sep. 14, 2013, and U.S. Provisional Application Ser. No. 61/919,822, filed Dec. 23, 2013. The contents of the parent applications are hereby incorporated by reference.

### TECHNICAL FIELD

The disclosure relates to a mechanical device that helps users manage and organize keys for one or multiple residential or commercial properties.

### BACKGROUND

In many cases, owners and managers of one or multiple residential or commercial properties need to organize the keys for such properties. Often times the properties—and thus the corresponding keys—have complex tiered relationships, making the organizing efforts more difficult. A manager of an apartment building may need to organize a large number of keys for not only the apartments, but also for common areas such as laundry rooms and basement. It is very challenging for the manager to keep track of all the keys, retrieve specific keys promptly and accurately, and return the keys to its original place. There is an inherent tiered structure to the relationships among these keys.

Conventional key accessories, such as key chains, key boxes or key cabinets, do not support the configuration of keys that resembles their inherent relationships.

Typical key chains such as key rings in the market today are very simplistic. They don't have label areas. Important to organizing keys is the labeling of the keys in such a way that supports the inherent relationships among keys. Some chains are sold with labels, but these labels are in the form of separate tags. These tags are not an integral part of key chains, rather they are separate objects, most often hanging off the key chains. These separate tags result in bulky key chains.

With the typical key rings, a user can manually configure several key rings into a tiered structure. But these key rings were not designed to support this type of configuration for two reasons: 1) it is difficult to attach and detach the key rings from each other on a frequent basis, 2) there is no labeling space on the key ring itself, which means the tiered structure can't be described.

Some new key chain products such as the carabineer, S-biner or snap hook types are easy to attach and detach the key chains from each other, allowing easy configuration of the tiered structures. However, these key chains don't have label area built in. Therefore it is not easy for a user to label the keys and describe the tiered structure.

Some inventions have been directed to mechanical devices that help organize keys. The key organizer can be a key cabinet that contains swingable key hangers, and the swing sheets that secure the key hangers. The key holder assembly supports the tiered structure of the keys. The present invention presents certain embodiments of the key holder assembly as described in the previous U.S. patent application 61/924,712.

Several embodiments of this invention are illustrated in the accompanying drawings and will be described in more detail herein below.

### SUMMARY

The present disclosure relates to a key holder assembly that helps owners or managers of one or multiple residential or commercial properties to better organize keys to their properties. Similarly, this invention helps garage owners, hotel managers, and campus managers who are in possession of many keys. More specifically, the present invention supports the inherent structure of the keys by providing a labeling system and by enabling easy attachment and detachment of key chains or keys.

A key holder assembly includes one or more key holders. Each key holder can be thought of as a key chain with its own unique design. Each key holder has a built-in label area, a fastening mechanism and an attachment mechanism. The key holder assembly can be configured to represent the tiered structure of the keys by connecting a key holder to another key holder, and connecting keys to the key holders. The label area contains one or more labels that describe the attached keys and therefore the key structure. The fastening mechanism can be a snap hook or a carabineer that is releasable, but may also be other mechanisms. By connecting one or more key holders (second tier) to another key holder (first tier), it creates a two-tiered structure. Similarly, one can connect one or more key holders (third tier) to a second tier key holder, thus creating a three tiered tree structure. Keys hang off the key holders in the key holder assembly. The key holder assembly can take on the shape of a tree of any breadth and depth which is described through the labeling system.

In general, the present invention succeeds in conferring the following, and others not mentioned, desirable and useful benefits and objectives.

The key holder assembly can be configured to closely represent the tiered structure of the keys by connecting a key holder to another key holder, and connecting keys to the key holders, thus forming the key holder assembly with the tiered structure. The key holder assembly can take on the shape of a tree of any breadth and depth which is described through the labeling system.

The key holder assembly has the following features:
1) built-in label areas that are small enough to be space efficient but big enough to for a user to write on a label and put the label onto a label area;
2) a mechanism to easily attach and detach key holders or keys from each other;
3) a secure locking mechanism when the carabineer is in a locked position. The gate can't be accidentally opened, otherwise keys fall out. The present invention addresses this issue with a special design of the wire clip of a carabineer. Alternatively, through the modification to the carabineer tip, the same goal can be achieved.
4) a configurable multi-tiered tree structure that reflects the inherent structure of the keys and can be labeled through a labeling system.

From a user point of view, a user can re-configure the key holder assembly easily by attaching and detaching the key holders or the keys. For instance, he can remove a specific key holder from a key holder assembly and later return the key holder to the key holder assembly. The adhesive labels can be placed onto the label area of the key holders.

### DESCRIPTION OF DRAWINGS

FIG. 1 shows the schematic tiered structure of the property keys in an apartment building

FIG. 2 shows the releasable fastening mechanism of a carabineer.

FIG. 3 Shows the unlocked and locked positions of the fastening mechanism in FIG. 2.

FIG. 4 shows front and side views of the locking mechanism with a wire clip as shown in FIG. 3.

FIG. 5 shows different views of the wire clip of FIG. 4 as a standalone component.

FIG. 6 Shows a slightly different embodiment of the wire clip of the locking mechanism.

FIG. 7 shows various views of a key holder.

FIG. 8 shows a side and a top view of the key holder in FIG. 7.

FIG. 9 shows a key holder assembly where keys hangs off the key holder.

FIG. 10 shows another key holder assembly where second tier key holders hang off the first tier key holder.

FIG. 11 shows a front view of another key holder.

FIG. 12 shows another key holder assembly where keys hang off the key holder.

FIG. 13 shows another key holder assembly where second tier key holders hang off the first tier key holder.

FIG. 14 shows a front view of another key holder.

FIG. 15 shows a wire clip and the carabineer tip of the fastening mechanism as a locking mechanism.

FIG. 16 shows another key holder assembly where second tier key holders hang off the first tier key holder.

FIG. 17 shows another key holder assembly where second tier key holders hang off the first tier key holder.

FIG. 18 shows a front view of another key holder.

FIG. 19 shows another key holder assembly where second tier key holders hang off the first tier key holder.

FIG. 20 shows a front view of another key holder.

### DETAILED DESCRIPTION

The preferred embodiments of the present disclosure will now be described with reference to the drawings. Identical elements in the various figures are identified, as far as possible, with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

For clarity purposes, some identical elements in the same figure are not all marked. Marking of one of the identical elements serves as an indication for the reference to the other elements.

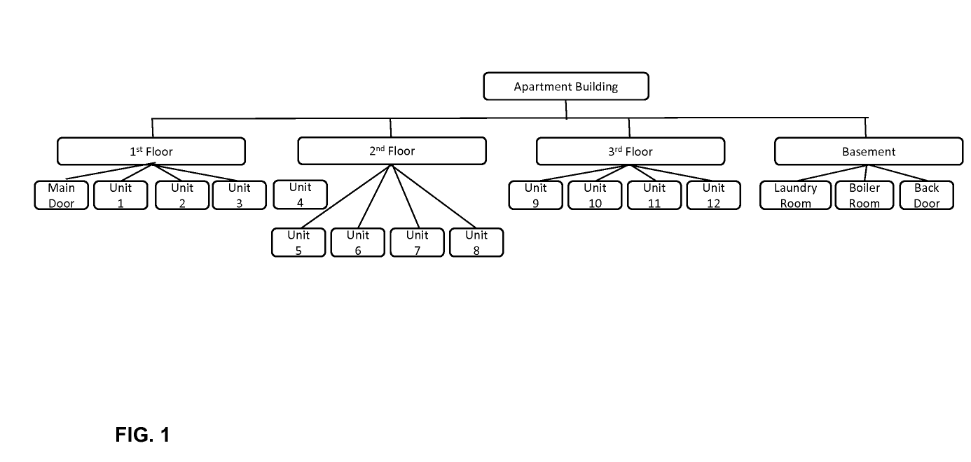

FIG. 1 shows the inherent structure of properties keys in an apartment building. The keys can be organized based on the inherent structure such as by floors and by units. If these keys were hang row by row, as they are typically hang in a typical key cabinet, then it bears no resemblance to the inherent structure. Different buildings or properties have their own inherent structures with different depth and width. Being able to support various structures dynamically through configuration is the key.

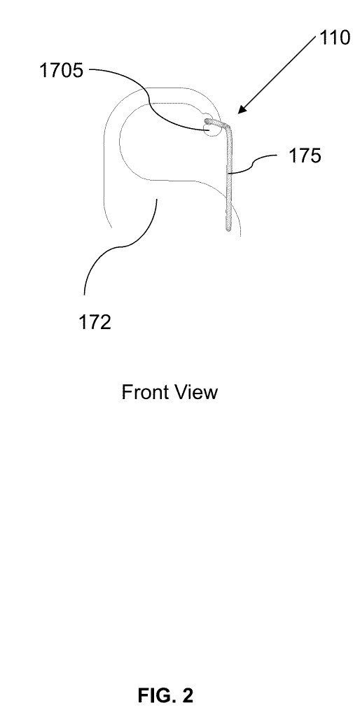

FIG. 2 shows the releasable fastening mechanism 110 of a carabineer with a wire clip 175, carabineer tip 1705 and a carabineer frame 172. The wire clip and the carabineer tip together form the locking mechanism so that the gate doesn't accidentally open. The wire clip has the built-in tension to lean towards to the carabineer tip. So under normal condition, the gate is always closed. To further secure the lock, the carabineer tip has an indentation to receive the wire clip.

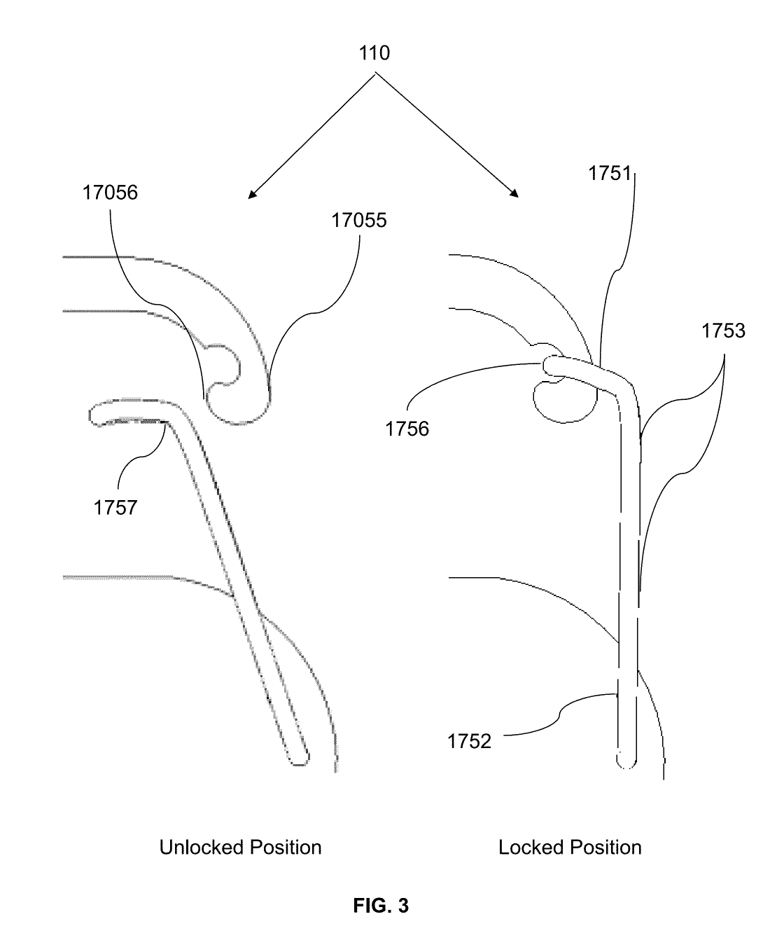

FIG. 3 shows the unlocked and locked positions of the fastening mechanism 110. Due to the fact that the fastening mechanism 110 has both the unlocked and unlocked positions, it is called a releasable fastening mechanism. The carabineer tip 1705 has an inside edge 17056 and an outside edge 17055

The wire clip 175 has three main parts: the head end 1751, the trunks 1753 and the tail ends 1752. The head end and the trunks form an angle at the point of the bend 17514. The bend 1757 separates the head end and the trunks. The bend typically has an angle between 30 to 90 degrees. The bend is formed so that the head end forms a loop which can wrap around the inside edge and the outside edge of the carabineer tip. The angle less than 30 degrees typically makes it harder for the head end to wrap around the carabineer tip.

As shown in FIG. 3, in an unlocked position, the entire head end 1751 is inside of the inside edge 17056. In a locked position, a portion of the head end (e.g., the tip of the head end 1756) is inside of the inside edge while the bend 1757 is outside of the outside edge 17055. In this locked position, the head end is considered to wrap around the carabineer tip.

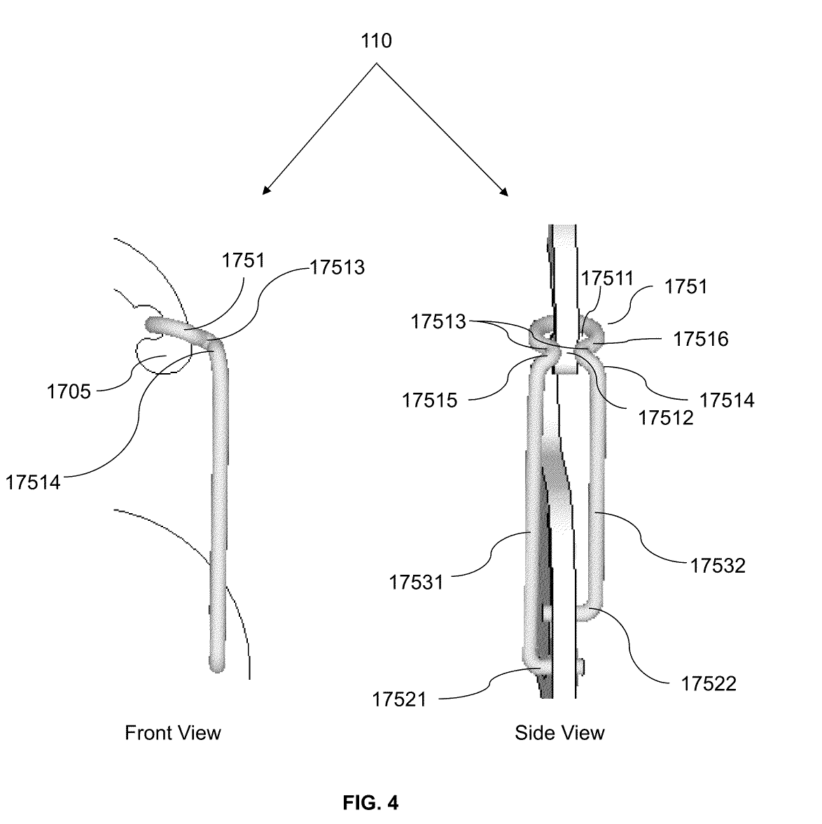

FIG. 4 shows the locking mechanism of the releasable fastening mechanism 110 which utilizes the wire clip 175 to snap into position. The figure shows the side view of the wire clip 175. The way the wire clip 175 works is that it has the spring to lean outward away from the releasable fastening mechanism 110 due to the tension in the wire itself. Therefore, the normal position of the wire clip 175 is to lean against the carabineer tip 1705, thus securely locking the releasable fastening mechanism 110. Pushing on the wire clip 175 against the carabineer tip 1705 allows the carabineer tip to squeeze through the wire clip and enter into a locked position. Pushing on the wire clip 175 away from the carabineer tip unlocks the fastening mechanism, thus allowing keys or key holders to go through.

FIG. 4 also shows the side view of the wire clip 175. The wire clip comprises the head end, the trunks and the tail ends. The tail ends of the wire clip are attached to the carabineer frame and can rotate along the surface of the carabineer frame. The tail ends 1752 comprise a first tail end 17521 and a second tail end 17522. The trunks 1753 comprise a first trunk 17531 and a second trunk 17532. The first trunk is between the head end and the first tail end, and the second trunk is between the head end and the second tail end. The head end 1751 of the wire clip 175 is shown to have an oval-shaped loop 17511 and two necks 17513. The necks 17513 form an opening 17512, where the first trunk and the second trunk close in (17514) and then flare out (17515). Typically, the opening 17512 is smaller than the width of the carabineer tip so that the carabineer tip has to squeeze through to enter inside the loop of the head end. The flaring out of the trunks (17515) is to help the carabineer tip align better against the necks so that it guides the carabineer tip to squeeze through.

The design of the head end 1751 is intended to do the following
1) The head end can wrap around both the inside and outside edges of the carabineer tip.
2) The carabineer tip 1705 to squeeze through the necks 17513 so that the carabineer tip 1705 enters inside the oval-shaped loop 17511 when it is in a locked position
3) The necks 17513 are to secure the locked position so that the gate won't accidentally open.

Practically speaking, to lock, a user will use his finger to push/pull the trunks 1753 against the carabineer tip 1705. There could be a clicking sound when the carabineer tip 1705 squeezes through the necks 17513 and lands inside the oval-shaped loop 17511. To unlock, the user will use his finger to push/pull against the trunks 1753 in opposite direction away from the carabineer tip 1705. Again there could be a clicking sound when the carabineer tip 1705 squeezes through the necks 17513 and lands outside of the oval-shaped loop 17511.

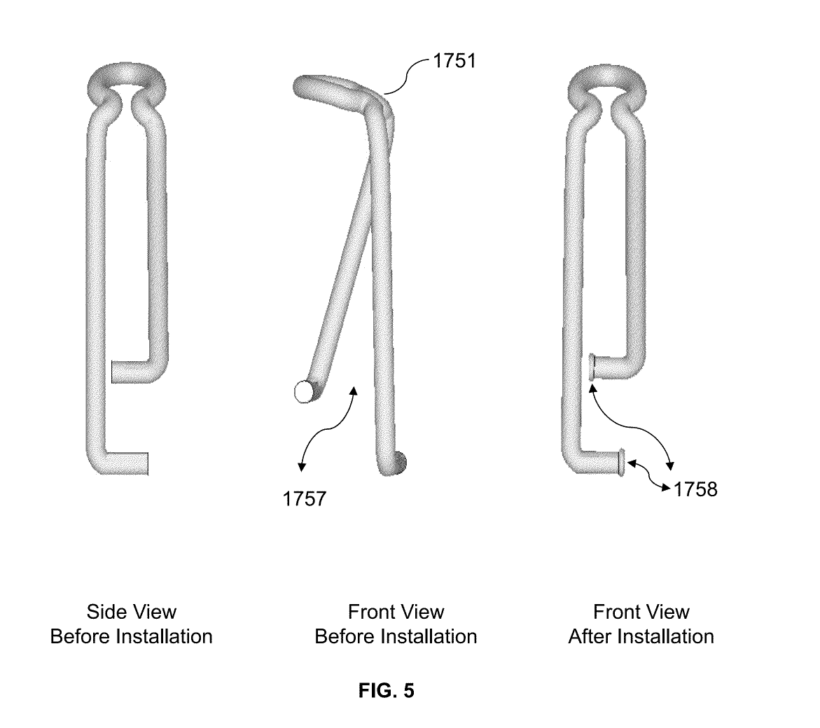

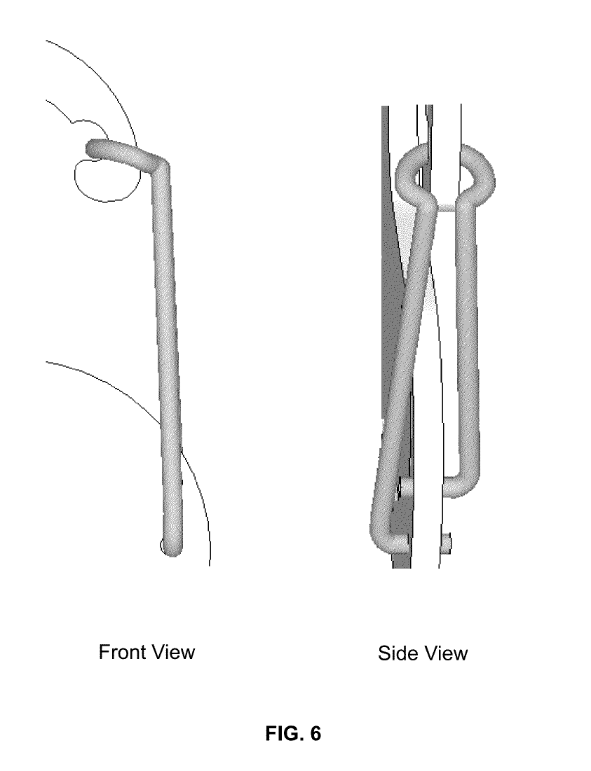

FIG. 5 shows the wire clip of FIG. 4 as a standalone component in the pre-installation views. The side view in the pre-installation view shows the shape of the head end clearly. The two tail ends are apart in its natural state, forming a gap 1757 in the front view before installation. When the wire clip is installed into the carabineer as shown in FIG. 4, the two tail ends are forced to come close towards each other, closing the gap 1757. This creates the tension in the wire clip. As a result, the head end of the wire clip 1751 leans towards the right in the front view of this figure. Stub 1758 is formed after the wire clip is installed on the carabineer as shown in the side view after installation. The stub prevents the wire clip ends from slipping out the holes on the carabineer frame. The same design for pre-installation and after-installation applies to the embodiment in FIG. 6 as well.

FIG. 6 shows another embodiment of the wire clip with slightly different necks 17513. The trunks at the necks close in to form the narrow opening 17512, however the trunks don't flare out as shown in FIG. 4. An opening 17512 can be designed to have just the right width so that the carabineer tip 1705 can squeeze through. The most important thing is that the carabineer tip 1705 stays inside the oval-shaped loop 17511 when it is in a locked position.

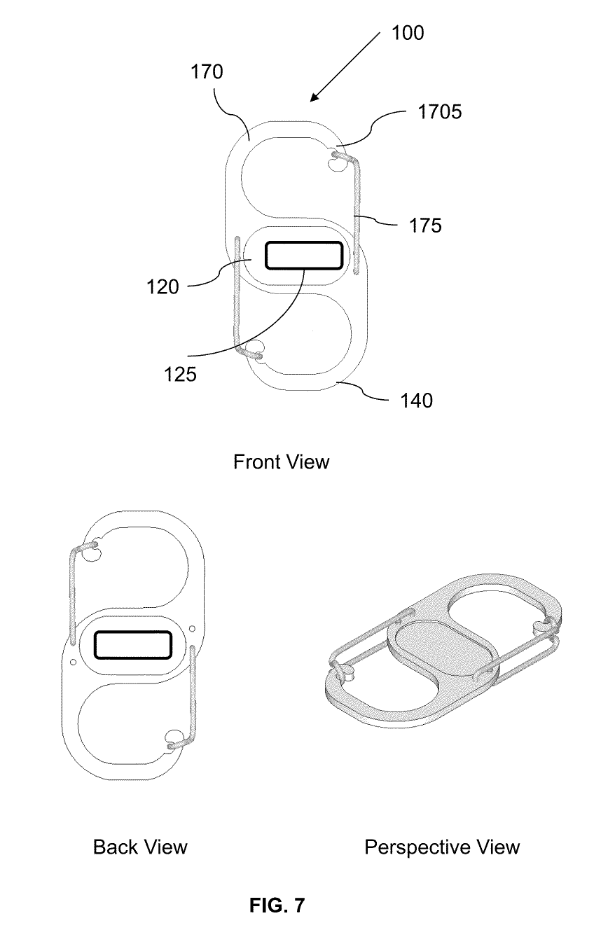

FIG. 7 shows a front view of a key holder 100, wherein the key holder 100 comprises: a label area 120 having at least one label 125; two carabineers 170 and 140. The label area 120 can be a solid plate. Label 125 can be adhesive labels made of paper, poly or other materials. Label 125 can be placed onto the label area. In this preferred embodiment, the two carabineers are identical, but facing opposite directions. Either one of them can be used as a fastening mechanism or an attachment mechanism. In this case, carabineer 170 is considered to have a releasable fastening mechanism attached to the top of the label area 120 and is capable of attaching to a higher tier key holder above it or to another abject such as a belt loop or bag; Carabineer 140 has a releasable attachment mechanism attached to the bottom of the label area 120 (carabineer 140) and is capable of attaching lower tiered key holders or keys to itself. In this preferred embodiment, both carabineers 170 and 140 utilize a wire clip 175 as a locking mechanism. Furthermore, the wire clip 175 on the top right corner of this figure is positioned similar to the wire clip positioned in the front view of FIG. 4. The head end of the wire clip leans to the right against the carabineer tip 1705.

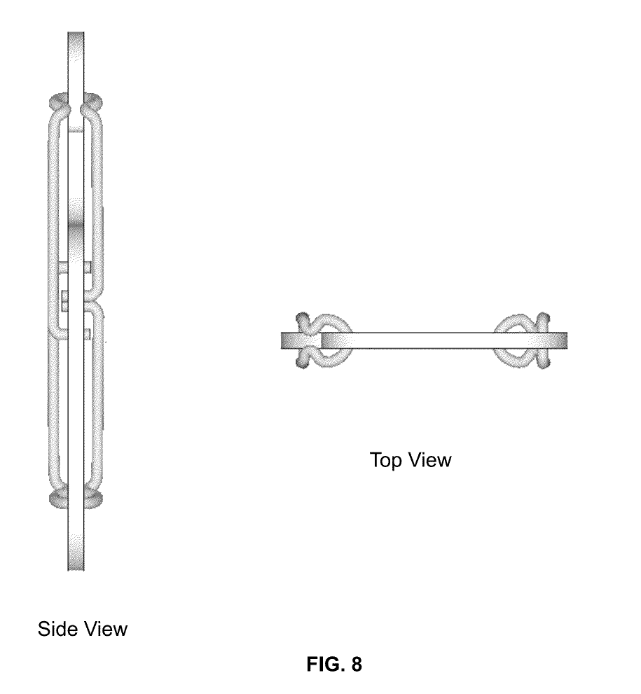

FIG. 8 shows the side view and the top down view of the key holder.

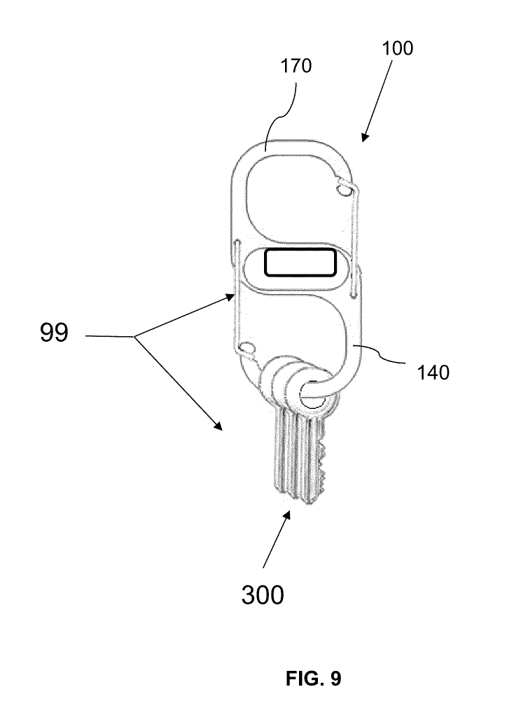

FIG. 9 shows a key holder assembly 99 that comprises a key holder 100 and keys 300 that are hanging off the key holder via carabineer 140 with a releasable attachment mechanism. There is one label here that can be used to label the group of keys below. Alternatively, there could be multiple labels in a label area that label the keys below in the same order that the keys are.

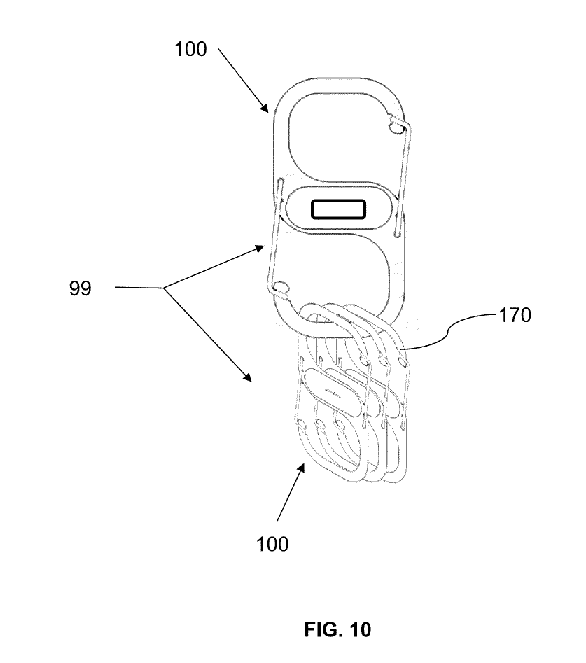

FIG. 10 shows a key holder assembly 99 wherein the first tier comprises a key holder 100 and the second tier comprises a number of key holders 100 of a different size, preferably a smaller size. The second-tier key holders 100 attach to the first tier key holder 100 via the fastening mechanism of carabineer 170. There is one label in the first tier that can be used to label the group of keys below such as 11 Maggie Ave (a property address). There are three labels in the second tier that can be used to label the group of keys below such as Floor 1, Floor 2 and Floor 3. Alternatively, there could be multiple labels in a label area that further label the keys below.

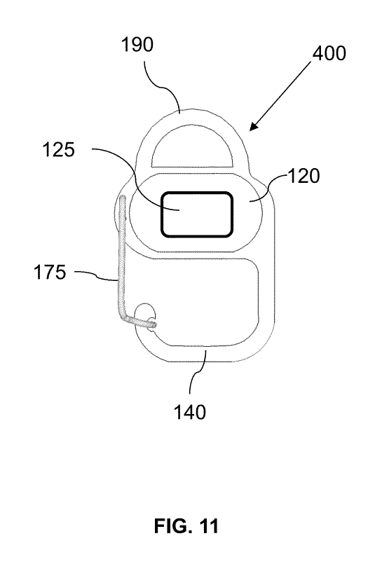

FIG. 11 shows a front view of another key holder 400, wherein the key holder 400 comprises: a label area 120 having at least one label 125; a carabineer 140; a fastening mechanism 190. The label area 120 can be a solid plate. Label 125 can be adhesive labels made of paper, poly or other materials. Label 125 can be placed onto the label area. In this preferred embodiment, since the fastening mechanism 190 is a loop with no opening, it is only capable of attaching itself to a higher tier key holder with a releasable attachment mechanism. The carabineer 140 is capable of attaching lower tiered key holders or keys to itself. The carabineer 140 utilizes a wire clip 175 similar to the one in FIG. 2.

The difference between FIG. 7 and FIG. 11 is the fastening mechanism. FIG. 11's fastening mechanism 190 doesn't have an unlocked position. Therefore it is not releasable. However, it is potentially more cost effect to manufacture. Additionally, it occupies much less space than the releasable fastening mechanism in carabineer 170 in FIG. 2. It is important for the key holders to take up as little space as possible while still allowing the labels to be big enough to write on.

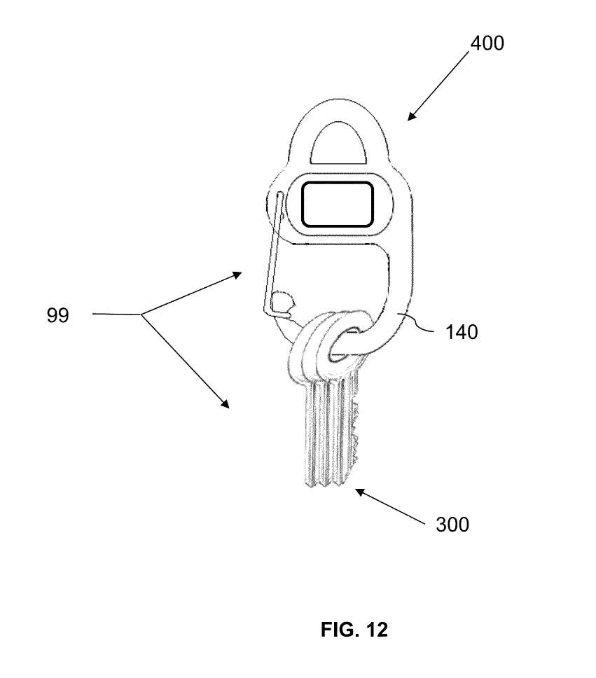

FIG. 12 shows a key holder assembly 99 that comprises a key holder 400 and keys 300 that are hanging off the key holder via the fastening mechanism of carabineer 140. There is one label here that can be used to label the group of keys below. Alternatively, there could be multiple labels in a label area that label the keys below in the same order that the keys are.

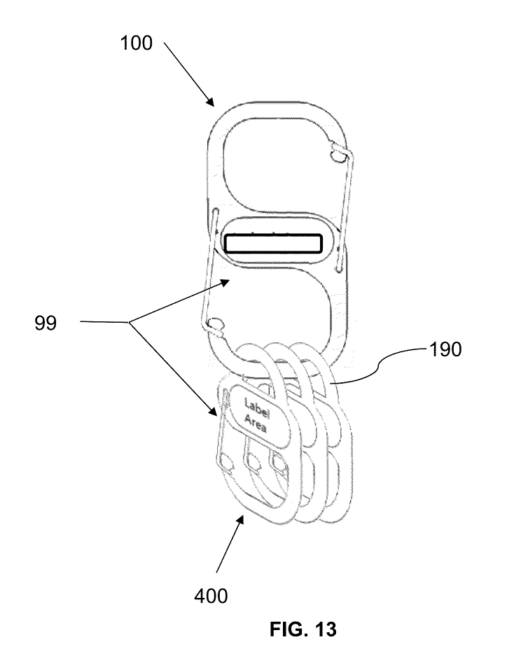

FIG. 13 shows a key holder assembly 99 wherein the first tier comprises a key holder 100 and the second tier comprises a number of key holders 400. The second-tier key holders 400 attach to the first tier key holder 100 via the fastening mechanism 190. There is one label in the first tier that can be used to label the group of keys below such as 11 Maggie Ave (a property address). There are three labels in the second tier that can be used to label the group of keys below such as Floor 1, Floor 2 and Floor 3. Alternatively, there could be multiple labels in a label area that further label the keys below.

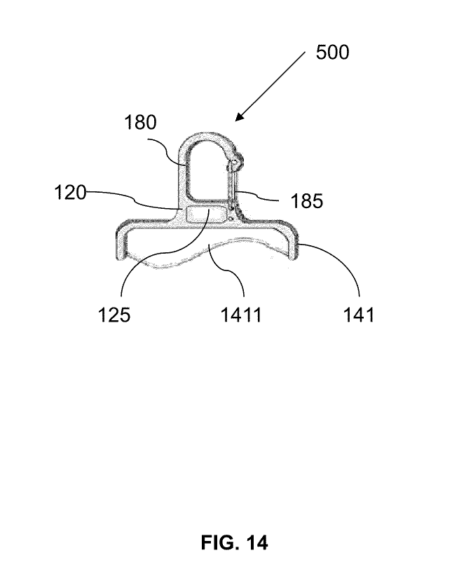

FIG. 14 shows a front view of a key holder 500, wherein the key holder 500 comprises: a label area 120 having at least one label 125; a releasable fastening mechanism 180 and an attachment mechanism 141. The label area 120 can be a solid plate. Label 125 can be adhesive labels made of paper, poly or other materials. Label 125 can be placed onto the label area. The releasable fastening mechanism uses a wire clip 185 as a locking mechanism. The attachment mechanism 141 is attached to the bottom of the label area 120 and is capable of providing a rack for the lower tiered key holders to hang off. Since attachment mechanism 141 is a loop with no opening, keys can't hang directly off it. Keys with rings or key holders that have a releasable fastening mechanism can hang off it. The attachment mechanism of 141 has an S-shaped rack 1411. The S shape lies on the horizontal plane with two ends of the S attached to either side of the attachment mechanism frame.

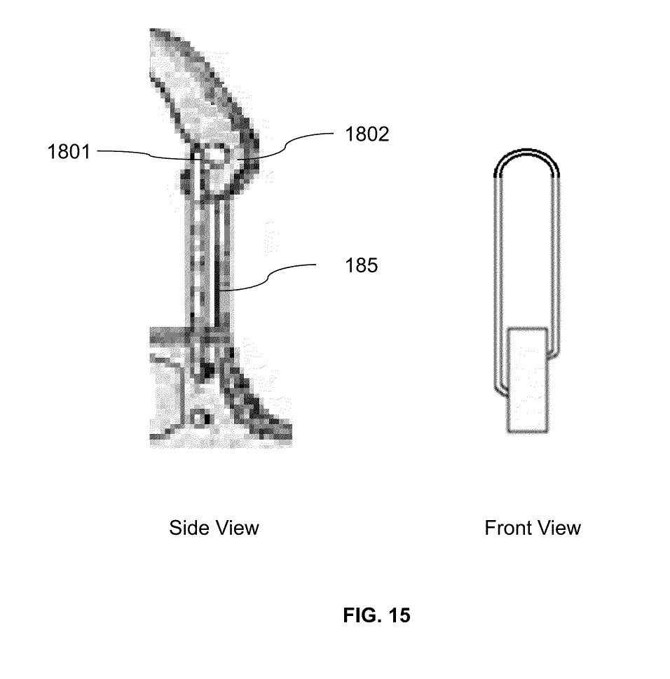

FIG. 15 shows the locking mechanism of the releasable fastening mechanism 180 which utilizes a wire clip 185 to snap into position. The wire clip 185 doesn't have the necks 17513 in FIG. 4. Instead, the fastening mechanism's carabineer tip 1802 has an oval-shaped loop where the wire clip 185 passes through the opening 1801 and snaps into position. The opening is just big enough for the wire clip to squeeze through. This figure also shows a front view of the wire clip 185.

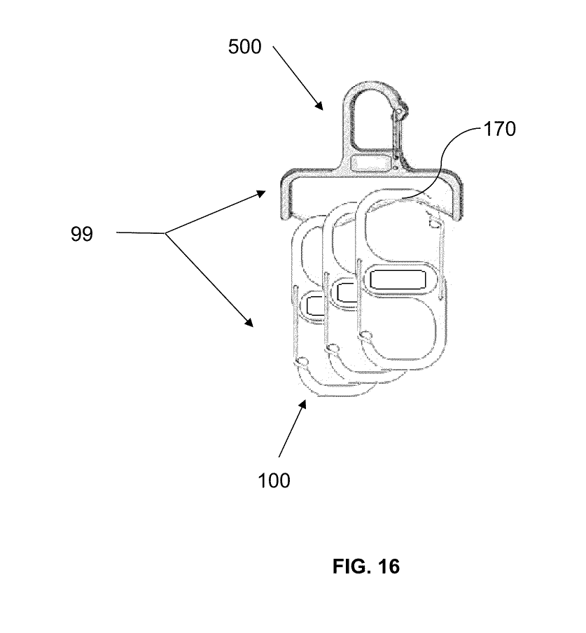

FIG. 16 shows a key holder assembly 99 wherein the first tier comprises a key holder 500 and the second tier comprises a number of key holders 100. The second-tier key holders 100 attach to the first tier key holder 500 via its releasable fastening mechanism. The S-shape of the rack 1411 as shown in FIG. 14 allows the second-tier key holders to turn almost parallel to each other and to the first-tier key holder so that the entire key assembly can be flattened for easy storage. Without the S-shape, often times the second-tier key holders tend to be orthogonal or on an angle to the first-tier key holder.

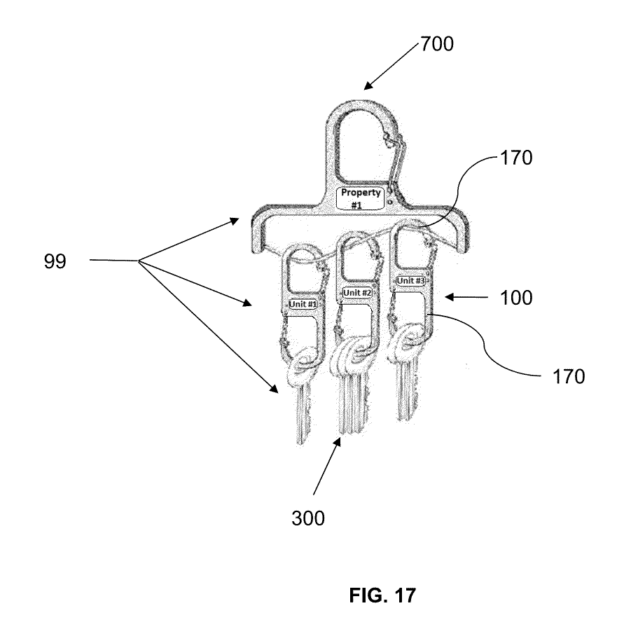

FIG. 17 shows a key holder assembly 99 wherein the first tier comprises a key holder 700, the second tier comprises a number of key holders 100 and the third tier comprises a number of keys 300. The second-tier key holders 100 attach to the first tier key holder 700 via its releasable fastening mechanism. Keys 300 attach to the second-tier key holders via the attachment mechanism. The difference between key holder 700 and the key holder 500 is the locking mechanism. Key holder 700 has the wire clip 175 as shown in FIG. 2.

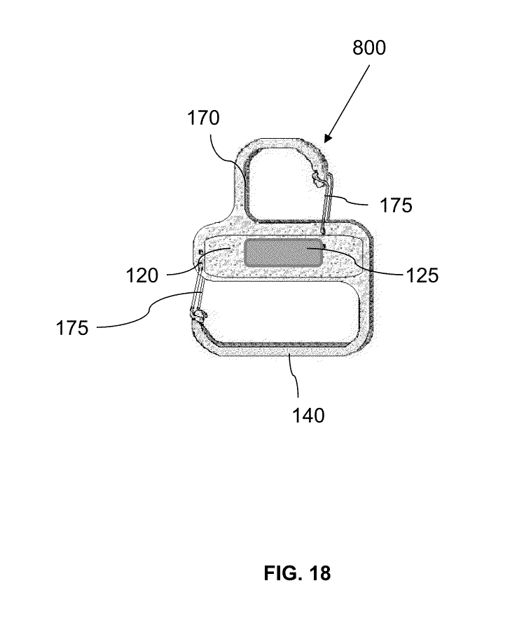

FIG. 18 shows a front view of a key holder 800, wherein the key holder 800 comprises: a label area 120 having at least one label 125; a carabineer 170 and a carabineer 140. The label area 120 can be a solid plate. Label 125 can be adhesive labels made of paper, poly or other materials. Label 125 can be placed onto the label area. Both the releasable fastening mechanism and the releasable attachment mechanism use a wire clip 175. The carabineer 140 is attached to the bottom of the label area 120 and is capable of attaching lower tiered key holders or keys to itself. As compared to key holder 100, key holder 800 has a bigger or broader carabineer 140 so that more keys or key holders can hang off it.

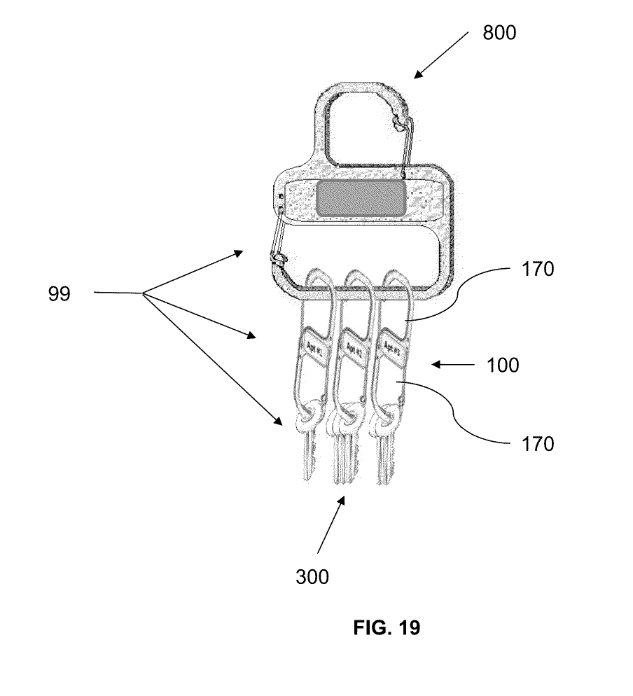

FIG. 19 shows a key holder assembly 99 wherein the first tier comprises a key holder 800, the second tier comprises a number of key holders 100 and the third tier comprises a number of keys 300. The second-tier key holders 100 attach to the first tier key holder 800 via its releasable fastening mechanism. Keys 300 attach to the second-tier key holders via the attachment mechanism.

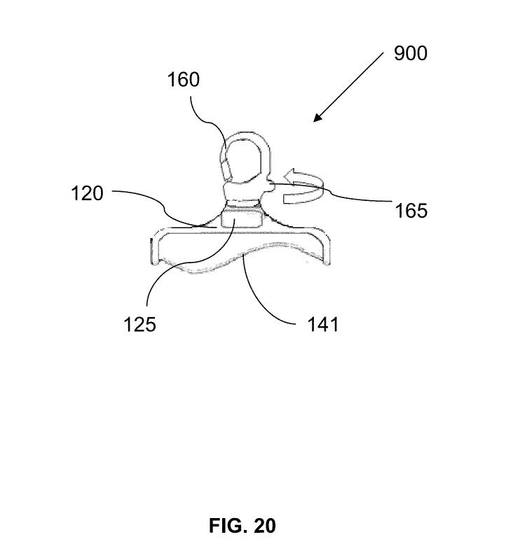

FIG. 20 shows a front view of a key holder 900, wherein the key holder 900 comprises: a label area 120 having at least one label 125; a releasable fastening mechanism 160 and an attachment mechanism 141. The label area 120 can be a solid plate. Label 125 can be adhesive labels made of paper, poly or other materials. Label 125 can be placed onto the label area. The releasable fastening mechanism 160 is a snap hook. The snap hook can be rotatable. The snap hook has a trigger 165. When the trigger 165 is pressed down, it pulls open the gate via a spring on the inside. When the trigger 165 is released, the fastening mechanism is locked. The attachment mechanism 141 is attached to the bottom of the label area 120 and is capable of providing a rack for the lower tiered key holders to hang off. Since attachment mechanism 141 is a loop with no opening, keys can't hang directly off it. Keys with rings or key holders that have a releasable fastening mechanism can hang off it. The attachment mechanism of 141 has an S-shaped rack 1411. The S shape lies on the horizontal plane with two ends of the S attached to either side of the attachment mechanism frame.

Although the above embodiments have been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A carabineer, comprising:
a carabineer frame having a tip, the tip having a width, an inside edge and an outside edge; and
a wire clip comprising a head end, first and second tail ends, and first and second trunks, the first trunk being between the head end and the first tail end and the second trunk being between the head end and the second tail end;
wherein the head end has two necks; and the first and second tail ends of the wire clip are attached to the carabineer frame.

2. The carabineer of claim 1, wherein the necks form an opening having a width smaller than the width of the tip.

3. The carabineer of claim 1, wherein a portion of the head end is inside of the inside edge of the tip while the necks of the head end are outside of the outside edge of the tip while the carabineer is in a locked position.

4. The carabineer of claim 2, wherein the first and second trunks close in and flare out at the point of the opening.

5. A carabineer of claim 2, wherein the tip is capable of squeezing through the opening.

6. The carabineer of claim 1, wherein the tip has an indentation that receives the head end of the wire clip.

7. A key holder, comprising:
a fastening mechanism;
an attachment mechanism; and
a key holder frame having a built-in label area, the key holder frame connecting to the fastening mechanism and the attachment mechanism;
at least one removable label attached to the label area.

8. The key holder of claim 7, wherein at least one of the fastening mechanism and the attachment mechanism is a carabineer, wherein the carabineer comprises:
a carabineer frame having a tip, the tip having a width, an inside edge and an outside edge; and
a wire clip comprising a head end, first and second tail ends, and first and second trunks, the first trunk being between the head end and the first tail end and the second trunk being between the head end and the second tail end;
wherein the head end has two necks; and the first and second tail ends of the wire clip are attached to the carabineer frame.

9. The key holder of claim 8, wherein a portion of the head end is inside of the inside edge of the tip while the first and second trunks are outside of the outside edge of the tip while the carabineer is in a locked position.

10. The key holder of claim 9, wherein the fastening mechanism has a locked position and an unlocked position, making the fastening mechanism releasable.

11. The key holder of claim 10, wherein the releasable fastening mechanism is a carabineer.

12. The key holder of claim 10, wherein the releasable fastening mechanism is a snap hook.

13. The key holder of claim 7, wherein the fastening mechanism is a loop with no opening.

14. The key holder of claim 9, wherein the attachment mechanism has a locked and an unlocked position, making the attachment mechanism releasable.

15. The key holder of claim 14, wherein the releasable attachment mechanism is a carabineer.

16. The key holder of claim 14, wherein the releasable attachment mechanism is a snap hook.

17. The key holder of claim 7, wherein the attachment mechanism is a loop with no opening.

18. The key holder of claim 17, wherein at least a portion of the loop is an S shape.

19. The key holder of claim 14, wherein the releasable attachment mechanism is capable of hanging a plurality of keys.

20. The key holder of claim 7, wherein the label identifies the keys underneath it.

21. The key holder of claim 20, wherein the label is an adhesive label.

22. A key holder assembly, comprising:
a first tier that comprises a first tier key holder, the first tier key holder being the key holder of claim 7.

23. The key holder assembly of claim 22, further comprising:
at least one key hanging off the first tier key holder.

24. The key holder assembly of claim 23, further comprising:
a second tier that comprises at least one second tier key holder,
wherein the second tier key holder attaches to the attachment mechanism of the first tier key holder.

25. The key holder assembly of claim 24, wherein the second tier key holder comprises a releasable attachment mechanism and the key holder assembly further comprises at least one key hanging off the releasable attachment mechanism of the second tier key holder.

26. The key holder assembly of claim 22, further comprising a plurality of tiers, each comprising a key holder, and the tiers of the key holder assembly is configured to form a tiered key structure.

27. The key holder assembly of claim 26, wherein the lowest tier key holder comprises a releasable attachment mechanism and the key holder assembly further comprises a plurality of keys hanging off the releasable attachment mechanism of the lowest tier key holder.

28. The key holder assembly of claim 22, wherein the key holder assembly comprises a plurality of labels that identify the tiered key structure.

29. A wire clip, comprising a head end, first and second tail ends, and first and second trunks, the first trunk being between the head end and the first tail end and the second trunk being between the head end and the second tail end;
wherein the head end forms an angle from 30-90° with at least one of the first and second trunks.

30. The wire clip of claim 29, wherein the head end comprises a loop.

31. The wire clip of claim 30, wherein the loop forms a first neck with the first trunk and forms a second neck with the second trunk.

32. The wire clip of claim 31, wherein the loop forms an opening at the first and second necks.
